(19) United States
(12) Patent Application Publication
(10) Pub. No.: US 2024/0178963 A1
(43) Pub. Date: May 30, 2024

(54) METHODS, DEVICES AND COMPUTER STORAGE MEDIA FOR COMMUNICATION

(71) Applicant: NEC CORPORATION, Tokyo (JP)

(72) Inventors: Yukai GAO, Beijing (CN); Lin LIANG, Beijing (CN); Gang WANG, Beijing (CN)

(73) Assignee: NEC CORPORATION, Tokyo (JP)

(21) Appl. No.: 18/284,213

(22) PCT Filed: Apr. 1, 2021
(86) PCT No.: PCT/CN2021/084857

§ 371 Date: Sep. 26, 2023

(51) Int. Cl. H04L 5/00; H04L 43/0811; H04W 72/12; H04W 72/21; H04W 80/02

(52) U.S. Cl. CPC H04L 5/0051; H04L 43/0811; H04W 72/12; H04W 72/21; H04W 80/02

(57) ABSTRACT

Embodiments of the present disclosure relate to methods, devices and computer storage media for communication. A method comprises receiving, at a terminal device, a configuration from a network device, wherein the configuration indicates that each of a group of cells serving the terminal device is associated with at least one of a plurality of transmission and reception points (TRPs) coupled with the network device; and in response to a beam failure being detected on a cell in the group of cells, transmitting a beam failure recovery request to the network device, wherein the beam failure recovery request comprises TRP information related to the beam failure detected on the cell.

### TECHNICAL FIELD

Embodiments of the present disclosure generally relate to the field of telecommunication, and in particular, to methods, devices and computer storage media for communication.

### BACKGROUND

Recently, enhancements on the support for multi-transmission and reception point (multi-TRP) deployment have been discussed. For example, it has been proposed to identify and specify features to improve reliability and robustness for physical channels (such as, Physical Downlink Control Channel (PDCCH), Physical Uplink Shared Channel (PUSCH) and/or Physical Uplink Control Channel (PUCCH)) other than Physical Downlink Shared Channel (PDSCH) using multi-TRP and/or multi-panel with Release 16 reliability features as a baseline. It has been proposed to identify and specify quasi co-location (QCL)/transmission configuration indicator (TCI) related enhancements to enable inter-cell multi-TRP operations, assuming multi-downlink control information (multi-DCI) based multi-PDSCH reception. It has also been proposed to evaluate and, if needed, specify beam management related enhancements for simultaneous multi-TRP transmission with multi-panel reception.

### SUMMARY

In general, example embodiments of the present disclosure provide methods, devices and computer storage media for communication.

In a first aspect, there is provided a method of communication. The method comprises receiving, at a terminal device, a configuration from a network device, wherein the configuration indicates that each of a group of cells serving the terminal device is associated with at least one of a plurality of TRPs coupled with the network device; and in response to a beam failure being detected on a cell in the group of cells, transmitting a beam failure recovery request to the network device, wherein the beam failure recovery request comprises TRP information related to the beam failure detected on the cell.

In a second aspect, there is provided a method of communication. The method comprises transmitting, from a network device, a configuration to a terminal device, wherein the configuration indicates that each of a group of cells serving the terminal device is associated with at least one of a plurality of TRPs coupled with the network device; and in response to a beam failure being detected on a cell in the group of cells, receiving a beam failure recovery request from the terminal device, wherein the beam failure recovery request comprises TRP information related to the beam failure detected on the cell.

In a third aspect, there is provided a terminal device. The terminal device comprises circuitry configured to perform the method according to the above first aspect of the present disclosure.

In a fourth aspect, there is provided a network device. The network device comprises circuitry configured to perform the method according to the above second aspect of the present disclosure.

In a fifth aspect, there is provided a computer program product comprising machine-executable instructions. The machine-executable instructions, when being executed, cause a machine to perform the method according to the above first or second aspect of the present disclosure.

In a sixth aspect, there is provided a computer readable medium having instructions stored thereon. The instructions, when executed on at least one processor, causing the at least one processor to perform the method according to the above first or second aspect of the present disclosure.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1 illustrates an example communication network in which embodiments of the present disclosure can be implemented;

FIG. 2 illustrates an example signaling chart in accordance with some embodiments of the present disclosure;

FIG. 3 illustrates an example of embodiments of the present disclosure;

FIG. 4 illustrates an example of embodiments of the present disclosure;

FIG. 5 illustrates an example of embodiments of the present disclosure;

FIG. 6 illustrates an example of embodiments of the present disclosure;

FIG. 7 illustrates an example of embodiments of the present disclosure;

FIG. 8 illustrates a flowchart of an example method in accordance with some embodiments of the present disclosure;

FIG. 9 illustrates a flowchart of an example method in accordance with some embodiments of the present disclosure; and

FIG. 10 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘some embodiments’ and ‘an embodiment’ are to be read as ‘at least some embodiments.’ The term ‘another embodiment’ is to be read as ‘at least one other embodiment.’ The terms ‘first,’ ‘second,’ and the like may refer to different or same objects. Other definitions, explicit and implicit, may be included below.

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

As described above, it has been proposed to evaluate and, if needed, specify beam management related enhancements for simultaneous multi-TRP transmission with multi-panel reception. However, in current 3GPP specifications, there is no detailed design about multi-TRP based beam failure recovery.

Embodiments of the present disclosure provide a solution to solve the above problem and/or one or more of other potential problems. According to this solution, in response to a beam failure being detected by a terminal device on a cell in a group of cells, the terminal device may transmit a beam failure recovery request (BFRQ) to a network device, where the BFRQ comprises TRP information related to the beam failure detected on the cell. For example, the TRP information may indicate at least one of the following: the number of TRPs related to the beam failure detected on the cell, a TRP index related to the beam failure detected on the cell, whether a new candidate beam is identified on a failed TRP, information about the new candidate beam if it is identified on the failed TRP, and so on. In this way, this solution can support multi-TRP based BFRQ.

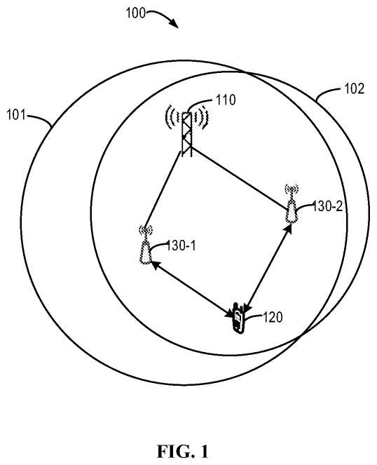

FIG. 1 shows an example communication network 100 in which embodiments of the present disclosure can be implemented. The network 100 includes a network device 110 and a terminal device 120 served by the network device 110. The network 100 may provide one or more serving cells to serve the terminal device 120.

As used herein, the term “terminal device” refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Internet of Everything (IoE) devices, machine type communication (MTC) devices, device on vehicle for V2X communication where X means pedestrian, vehicle, or infrastructure/network, or image capture devices such as digital cameras, gaming devices, music storage and playback appliances, or Internet appliances enabling wireless or wired Internet access and browsing and the like. For the purpose of discussion, in the following, some embodiments will be described with reference to UE as an example of the terminal device 120.

As used herein, the term ‘network device’ or ‘base station’ (BS) refers to a device which is capable of providing or hosting a cell or coverage where terminal devices can communicate. Examples of a network device include, but not limited to, a Node B (NodeB or NB), an Evolved NodeB (eNodeB or eNB), a next generation NodeB (gNB), a Remote Radio Unit (RRU), a radio head (RH), a remote radio head (RRH), a low power node such as a femto node, a pico node, and the like.

In some scenarios, carrier aggregation (CA) can be supported in the network 100, in which two or more CCs are aggregated in order to support a broader bandwidth. For example, in FIG. 1, the network device 110 may provide to the terminal device 120 a plurality of serving cells including one primary cell (Pcell) 101 corresponding to a primary CC and at least one secondary cell (Scell) 102 corresponding to at least one secondary CC. It is to be understood that the number of network devices, terminal devices and/or serving cells is only for the purpose of illustration without suggesting any limitations to the present disclosure. The network 100 may include any suitable number of network devices, terminal devices and/or serving cells adapted for implementing implementations of the present disclosure.

In some other scenarios, the terminal device 120 may establish connections with two different network devices (not shown in FIG. 1) and thus can utilize radio resources of the two network devices. The two network devices may be respectively defined as a master network device and a secondary network device. The master network device may provide a group of serving cells, which are also referred to as “Master Cell Group (MCG)”. The secondary network device may also provide a group of serving cells, which are also referred to as “Secondary Cell Group (SCG)”. For Dual Connectivity operation, a term “Special Cell (Spcell)” may refer to the Pcell of the MCG or the primary Scell (Pscell) of the SCG depending on if the terminal device 120 is associated to the MCG or the SCG, respectively. In other cases than the Dual Connectivity operation, the term “SpCell” may also refer to the PCell.

In one embodiment, the terminal device 120 may be connected with a first network device and a second network device (not shown in FIG. 1). One of the first network device and the second network device may be in a master node and the other one may be in a secondary node. The first network device and the second network device may use different radio access technologies (RATs). In one embodiment, the first network device may be a first RAT device and the second network device may be a second RAT device. In one embodiment, the first RAT device may be an eNB and the second RAT device is a gNB. Information related to different RATs may be transmitted to the terminal device 120 from at least one of the first network device and the second network device. In one embodiment, first information may be transmitted to the terminal device 120 from the first network device and second information may be transmitted to the terminal device 120 from the second network device directly or via the first network device. In one embodiment, information related to configuration for the terminal device configured by the second network device may be transmitted from the second network device via the first network device. Information related to reconfiguration for the terminal device configured by the second network device may be transmitted to the terminal device from the second network device directly or via the first network device. The information may be transmitted via any of the following: Radio Resource Control (RRC) signaling, Medium Access Control (MAC) control element (CE) or Downlink Control Information (DCI).

In the communication network 100 as shown in FIG. 1, the network device 110 can communicate data and control information to the terminal device 120 and the terminal device 120 can also communication data and control information to the network device 110. A link from the network device 110 to the terminal device 120 is referred to as a downlink (DL), while a link from the terminal device 120 to the network device 110 is referred to as an uplink (UL).

In some embodiments, for downlink transmissions, the network device 110 may transmit control information via a PDCCH and/or transmit data via a PDSCH to the terminal device 120. Additionally, the network device 110 may transmit one or more reference signals (RSs) to the terminal device 120. The RS transmitted from the network device 110 to the terminal device 120 may also referred to as a “DL RS”. Examples of the DL RS may include but are not limited to Demodulation Reference Signal (DMRS), Channel State Information-Reference Signal (CSI-RS), Sounding Reference Signal (SRS), Phase Tracking Reference Signal (PTRS), fine time and frequency Tracking Reference Signal (TRS) and so on.

In some embodiments, for uplink transmissions, the terminal device 120 may transmit control information via a PUCCH and/or transmit data via a PUSCH to the network device 110. Additionally, the terminal device 120 may transmit one or more RSs to the network device 110. The RS transmitted from the terminal device 120 to the network device 110 may also referred to as a “UL RS”. Examples of the UL RS may include but are not limited to DMRS, CSI-RS, SRS, PTRS, fine time and frequency TRS and so on.

The communications in the network 100 may conform to any suitable standards including, but not limited to, Global System for Mobile Communications (GSM), Long Term Evolution (LTE), LTE-Evolution, LTE-Advanced (LTE-A), Wideband Code Division Multiple Access (WCDMA), Code Division Multiple Access (CDMA), GSM EDGE Radio Access Network (GERAN), Machine Type Communication (MTC) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols.

The network device 110 (such as, a gNB) may be equipped with one or more TRPs or antenna panels. As used herein, the term “TRP” refers to an antenna array (with one or more antenna elements) available to the network device located at a specific geographical location. For example, a network device may be coupled with multiple TRPs in different geographical locations to achieve better coverage. The one or more TRPs may be included in a same serving cell or different serving cells.

It is to be understood that the TRP can also be a panel, and the panel can also refer to an antenna array (with one or more antenna elements). Although some embodiments of the present disclosure are described with reference to multiple TRPs for example, these embodiments are only for the purpose of illustration and help those skilled in the art to understand and implement the present disclosure, without suggesting any limitations as to the scope of the present disclosure. It is to be understood that the present disclosure described herein can be implemented in various manners other than the ones described below.

As shown in FIG. 1, for example, the network device 110 may communicate with the terminal device 120 via TRPs 130-1 and 130-2 (collectively referred to as “TRPs 130” or individually referred to as “TRP 130” in the following). For example, the TRP 130-1 may be also referred to as the first TRP, while the TRP 130-2 may be also referred to as the second TRP. As described above, the network device 110 may provide a group of cells to serve the terminal device 120. In some embodiments, the group of cells may be divided into a first subset of cells associated with the first TRP 130-1 and a second subset of cells associated with the second TRP 130-2. For example, the first subset of cells and the second subset of cells may include one or more overlapping cells or may not overlap each other.

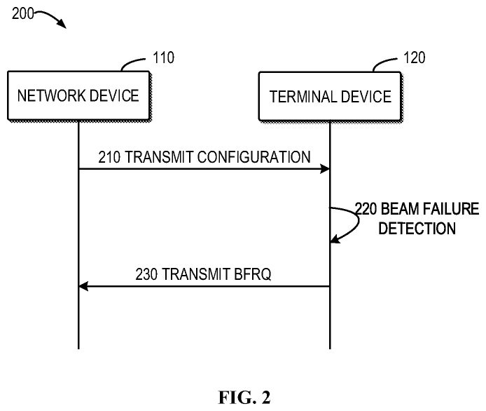

FIG. 2 illustrates a singling chart 200 in accordance with embodiments of the present disclosure. As shown in FIG. 2, the network device 110 may transmit 210 a configuration to the terminal device 120. In some embodiments, the configuration may indicate that each of a group of cells serving the terminal device 120 is associated with at least one of TRPs 130 coupled with the network device 110. For example, the configuration may be transmitted from the network device 110 to the terminal device 120 via at least one of Radio Resource Control (RRC) signaling, Medium Access Control (MAC) control element (CE) or Downlink Control Information (DCI). The terminal device 120 may perform 220 beam failure detection. In response to a beam failure being detected on a cell in the group of cells, the terminal device 120 may transmit a BFRQ to the network device 110 based on the configuration. In some embodiments, the BFRQ may comprise TRP information related to the beam failure detected on the cell.

In some embodiments, there may be M TRPs serving the terminal device 120, where M is a positive integer. For example, 1≤M≤4. For another example, M=2. In some embodiments, each TRP in the M TRPs may be represented by or associated with at least one of the following: a control resource set (CORESET) pool index; a CORESET group identifier (ID); a group of CORESETs; a SRS resource set; a SRS resource set ID; a TI state; a group of TCI states; an ID of a set of reference signals (RSs) for beam failure detection; an ID of a set of RSs for new beam identification; spatial relation information; a group of spatial relation information; a set of QCL parameters; a group of RSs for beam failure detection; a group of RSs for new beam identification; and so on. In the example as shown in FIG. 1B, M=2. In this case, the first TRP 130-1 may be represented by or associated with at least one of the following: a first CORESET pool index (for example, with a value of 0. For another example, CORESET(s) without configuration of the parameter “CORESET pool index”); a first CORESET group ID; a first group of CORESETs (For example, CORESET(s) configured with the first CORESET pool index or the first CORESET group ID. For another example, CORESET(s) not configured with the parameter “CORESET pool index” or the parameter “CORESET group ID”); a first SRS resource set; a first SRS resource set ID; a first TCI state; a first group of TCI states; an ID of a first set of reference signals (RSs) for beam failure detection; an ID of a second set of RSs for new beam identification; first spatial relation information; a first group of spatial relation information; a first set of QCL parameters; a first group of RSs for beam failure detection; a first group of RSs for new beam identification; and so on. The second TRP 130-2 may be represented by at least one of the following: a second CORESET pool index (for example, with a value of 1); a second CORESET group ID; a second group of CORESETs (For example, CORESET(s) configured with the second CORESET pool index or the second CORESET group ID.); a second SRS resource set; a second SRS resource set ID; a second TCI state; a second group of TCI states; an ID of a third set of reference signals (RSs) for beam failure detection; an ID of a fourth set of RSs for new beam identification; second spatial relation information; a second group of spatial relation information; a second set of QCL parameters; a second group of RSs for beam failure detection; a second group of RSs for new beam identification; and so on.

In the following, the terms “TRP”, “CORESET pool index”, “CORESET group ID”, “group of CORESETs”, “SRS resource set”, “SRS resource set ID”, “TCI state”, “group of TCI states”, “ID of a set of RSs for beam failure detection”, “ID of a set of RSs for new beam identification”, “spatial relation information”, “group of spatial relation information”, “set of QCL parameters”, “group of RSs for beam failure detection” and “group of RSs for new beam identification” can be used interchangeably. The terms “first TRP”, “first CORESET pool index”, “first CORESET group ID”, “first group of CORESETs”, “first SRS resource set”, “first SRS resource set ID”, “first TCI state”, “first group of TCI states”, “ID of a first set of RSs for beam failure detection”, “ID of a second set of RSs for new beam identification”, “first spatial relation information”, “first group of spatial relation information”, “first set of QCL parameters”, “first group of RSs for beam failure detection” and “first group of RSs for new beam identification” can be used interchangeably. The terms “second TRP”, “second CORESET pool index”, “second CORESET group ID”, “second group of CORESETs”, “second SRS resource set”, “second SRS resource set ID”, “second TCI state”, “second group of TCI states”, “ID of a third set of RSs for beam failure detection”, “ID of a fourth set of RSs for new beam identification”, “second spatial relation information”, “second group of spatial relation information”, “second set of QCL parameters”, “second group of RSs for beam failure detection” and “second group of RSs for new beam identification” can be used interchangeably. The terms “PUSCH” and “PUSCH MAC CE” can be used interchangeably.

In some embodiments, as described above, the network device 110 may provide a group of cells for serving the terminal device 120. In the group of cells, there may be one cell for conveying PUCCH and at least one secondary Scell. In the following, the cell for conveying PUCCH may also be represented as “Cell-1” and the at least one Scell may also be represented as “Cell-X”, where X is a positive integer and 2≤X≤32. For example, Cell-1 may be an Scell for conveying PUCCH (also referred to as “PUCCH-Scell”), Pcell, Pscell or Spcell. In some embodiments, Cell-1 may be associated with two TRPs 130-1 and 130-2, or may be associated with one of the TRPs 130-1 and 130-2. In some embodiments, at least one of Cell-X may be associated with two TRPs 130-1 and 130-2, or each of Cell-X may be associated with one of the TRPs 130-1 and 130-2.

In some embodiments, in the group of cells, there may be a subset of cells (such as, Y cells, where Y is an integer and 1≤Y≤X+1) configured for simultaneous beam failure recovery. In some embodiments, the subset of cells may be configured with a same set of RSs for beam failure detection (referred to as “q0_Y”) and/or a same set of RSs for new beam identification (referred to as “q1_Y”). In some embodiments, the q0_Y and/or q1_Y are within at least one cell of the subset of cells.

In some embodiments, in response to a beam failure being detected on at least one of the subset of cells, the terminal device 120 may provide an indication (such as, a beam failure indication) for the subset of cells to higher layers. In some embodiments, upon a request from higher layers, the terminal device 120 may provide to higher layers whether there is at least one periodic CSI-RS configuration index and/or Synchronization Signal (SS)/Physical Broadcast Channel block (PBCH) index from the set q1_Y with corresponding L1-RSRP measurements that are larger than or equal to the Q_{in,LR} threshold, and provides the periodic CSI-RS configuration indexes and/or SS/PBCH block indexes from the set, and/or the corresponding L1-RSRP measurements that are larger than or equal to the Q_{in,LR} threshold, if any. In some embodiments, in response to a beam failure being detected on at least one of the subset of cells, the terminal device 120 may transmit a BFRQ via a PUSCH MAC CE to the network device 110, where the PUSCH MAC CE comprises at least one of the following: index(es) of the subset (for example, if multiple subsets are configured in the group of cells), an indication of the subset of cells, an index of the TRP associated with the subset of cells, an indication of presence of a new beam (represented as “q_new”) identified for the subset of cells, a RS ID for the new beam for a periodic CSI-RS configuration or for a SS/PBCH block provided by higher layers, if any for the subset of cells. That is, the q_new is common to the subset of cells.

In some embodiments, the terminal device 120 may monitor PDCCH in all CORESETs or in first group of CORESETs or in second group of CORESETs on all the subset of cells by using the same antenna port QCL parameters as the ones associated with the corresponding index(ex) q_new, if any. In some embodiments, the index of the subset of cells may be indicated/reported by the PUSCH (for example, a first PUSCH) or MAC CE. In some embodiments, the monitoring may be applied after 28 symbols from a last symbol of a first PDCCH reception with a DCI format scheduling a PUSCH transmission. The HARQ process number for the PUSCH transmission or indicated in the first PDCCH or indicated in the DCI format may be the same as the HARQ process number of the first PUSCH. For example, the NDI field value for the PUSCH transmission or indicated in the first PDCCH or indicated in the DCI format may be different from the NDI filed value for the first PUSCH transmission. For example, the NDI field value for the PUSCH transmission or indicated in the first PDCCH or indicated in the DCI format may have a toggled value from the NDI filed value for the first PUSCH transmission. In some embodiments, the PDCCH may be monitored in the first group of CORESETs if a beam failure is detected in the first TRP or associated with the first group of CORESETs or associated with the first group of RSs for beam failure detection. In some embodiments, the PDCCH may be monitored in the second group of CORESETs if a beam failure is detected in the second TRP or associated with the second group of CORESETs or associated with the second group of RSs for beam failure detection.

In some embodiments, after 28 symbols from a last symbol of a PDCCH reception with a DCI format scheduling a PUSCH transmission with the same HARQ process number as the transmission of the first PUSCH and having a toggled NDI field value, the terminal device 120 may monitor PDCCH in all CORESETs on all of the subset of cells indicated by the MAC CE using the same antenna port QCL parameters as the ones associated with the corresponding index(es) q_new, if any.

In some embodiments, for example, the group of cells provided by the network device 110 for serving the terminal device 120 may be divided into a first subset of cells associated with the first TRP 130-1 and a second subset of cells associated with the second TRP 130-2. The first subset of cells may be configured with a first set of RSs for beam failure detection and a second set of RSs for new beam identification. The second subset of cells may be configured with a third set of RSs for beam failure detection and a fourth set of RSs for new beam identification. In some embodiments, in response to a beam failure being detected based on the first set of RSs, the terminal device 120 may transmit a first BFRQ to the network device 110, where the first BFRQ at least comprises an indication of the first TRP 130-1 or the first subset of cells. For example, the terminal device 120 may transmit the first BFRQ via a first PUSCH MAC CE, where the first PUSCH MAC CE comprises at least one of the following: index(es) of the first and second subsets, an indication of the first subset of cells, an index of the first TRP associated with the first subset of cells, an indication of presence of a new beam identified for the first subset of cells, a RS ID for the new beam for a periodic CSI-RS configuration or for a SS/PBCH block provided by higher layers, if any for the first subset of cells. In some embodiments, in response to a beam failure being detected based on the second set of RSs, the terminal device 120 may transmit a second BFRQ to the network device 110, where the second BFRQ at least comprises an indication of the second TRP 130-2 or the second subset of cells. For example, the terminal device 120 may transmit the second BFRQ via a second PUSCH MAC CE, where the second PUSCH MAC CE comprises at least one of the following: index(es) of the first and second subsets, an indication of the second subset of cells, an index of the second TRP associated with the second subset of cells, an indication of presence of a new beam identified for the second subset of cells, a RS ID for the new beam for a periodic CSI-RS configuration or for a SS/PBCH block provided by higher layers, if any for the second subset of cells.

It is to be understood that, the introduction of the subset of cells for simultaneous beam failure recovery can reduce the latency for beam management or beam failure recovery procedure. For example, the beam(s) may be common/similar for the subset of cells. That is, if a beam failure is detected on one cell in the subset of cells, the beam(s) for other cells in the subset of cells may also fail. It is also to be understood that, this scheme can also reduce the signaling overhead for beam failure recovery request. For example, the indication for the beam failure, whether a new beam is identified or not, and/or the index of the new beam (if it is identified) are common for the subset of cells. Thus, there is no need to report separately for each of the subset of cells.

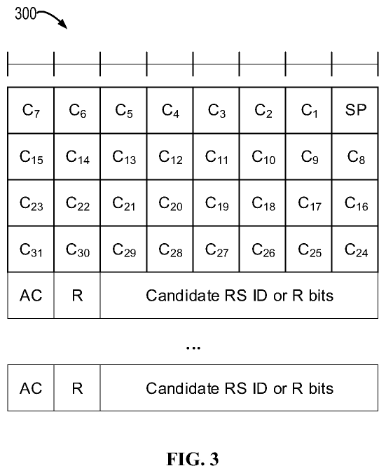

FIG. 3 illustrates an example BFRQ 300 in accordance with embodiments of the present disclosure. As shown in FIG. 3, the fields in the BFRQ 300 are defined as follows:
SP: This field indicates beam failure detection (as specified in clause 5.17 of TS 38.321) for the SpCell of this MAC entity. The SP field is set to 1 to indicate that beam failure is detected for SpCell only when BFR MAC CE or Truncated BFR MAC CE is to be included into a MAC PDU as part of Random Access Procedure (as specified in clause 5.1.3a and 5.1.4 of TS 38.321), otherwise, it is set to 0.
Cᵢ(BFR MAC CE): This field indicates beam failure detection (as specified in clause 5.17) and the presence of an octet containing the AC field for the SCell with ServCellIndex i as specified in TS 38.331. The Cᵢ field set to 1 indicates that beam failure is detected, the evaluation of the candidate beams according to the requirements as specified in TS 38.133 has been completed, and the octet containing the AC field is present for the SCell with ServCellIndex i. The Cᵢ field set to 0 indicates that the beam failure is either not detected or the beam failure is detected but the evaluation of the candidate beams according to the requirements as specified in TS 38.133 has not been completed, and the octet containing the AC field is not present for the SCell with ServCellIndex i. The octets containing the AC field are present in ascending order based on the ServCellIndex;
Cᵢ(Truncated BFR MAC CE): This field indicates beam failure detection (as specified in clause 5.17) for the SCell with ServCellIndex i as specified in TS 38.331. The Cᵢ field set to 1 indicates that beam failure is detected, the evaluation of the candidate beams according to the requirements as specified in TS 38.133 has been completed, and the octet containing the AC field for the SCell with ServCellIndex i may be present. The Cᵢ field set to 0 indicates that the beam failure is either not detected or the beam failure is detected but the evaluation of the candidate beams according to the requirements as specified in TS 38.133 has not been completed, and the octet containing the AC field is not present for the SCell with ServCellIndex i. The octets containing the AC field, if present, are included in ascending order based on the ServCellIndex. The number of octets containing the AC field included is maximised, while not exceeding the available grant size;
   NOTE: The number of the octets containing the AC field in the Truncated BFR MAC CE can be zero.
AC: This field indicates the presence of the Candidate RS ID field in this octet. If at least one of the SSBs with SS-RSRP above rsrp-ThresholdBFR amongst the SSBs in candidateBeamRSSCellList or the CSI-RSs with CSI-RSRP above rsrp-ThresholdBFR amongst the CSI-RSs in candidateBeamRSSCellList is available, the AC field is set to 1; otherwise, it is set to 0. If the AC field set to 1, the Candidate RS ID field is present. If the AC field set to 0, R bits are present instead.
Candidate RS ID: This field is set to the index of an SSB with SS-RSRP above rsrp-ThresholdBFR amongst the SSBs in candidateBeamRSSCellList or to the index of a CSI-RS with CSI-RSRP above rsrp-ThresholdBFR amongst the CSI-RSs in candidateBeamRSSCellList. Index of an SSB or CSI-RS is the index of an entry in candidateBeamRSSCellList corresponding to the SSB or CSI-RS. Index 0 corresponds to the first entry in the candidateBeamRSSCellList, index 1 corresponds to the second entry in the list and so on. The length of this field is 6 bits.
R: Reserved bit, set to 0.

In some embodiments, in response to a beam failure being detected on a cell in the group of cells, the terminal device 120 may transmit a BFRQ via a PUSCH MAC CE to the network device 110. In some embodiments, even if the cell is configured with multiple TRPs and configured to support multi-TRP beam failure recovery, the PUSCH MAC CE may comprise information about only one TRP. In some embodiments, the PUSCH MAC CE may comprise an indication of a TRP index that is common to all cells reported in the PUSCH MAC CE. For example, the indication may occupy 1 bit. In some embodiments, for a cell configured with multiple TRPs and configured to support multi-TRP beam failure recovery, value 0 may indicate that the first TRP fails if a beam failure is detected on the cell and value 1 may indicate that the second TRP fails if a beam failure is detected on the cell. In some embodiments, for a cell configured with only one TRP, the indication in the field can be ignored or reserved. In some embodiments, for a cell configured with only one TRP, beam failure recovery request for the cell may be included in the PUSCH for beam failure recovery request for the first TRP.

In some embodiments, in response to a beam failure being detected on a cell in the group of cells, the terminal device 120 may transmit a BFRQ via a PUSCH MAC CE to the network device 110. In some embodiments, even if the cell is configured with multiple TRPs and configured to support multi-TRP beam failure recovery, the PUSCH MAC CE may comprise information about only one TRP. In some embodiments, the PUSCH MAC CE may comprise an indication of a respective TRP index for each of cells reported in the PUSCH MAC CE. For example, the indication may occupy 1 bit. In some embodiments, for a cell configured with multiple TRPs and configured to support multi-TRP beam failure recovery, value 0 may indicate that the first TRP fails if a beam failure is detected on the cell and value 1 may indicate that the second TRP fails if a beam failure is detected on the cell. In some embodiments, for a cell configured with only one TRP, the indication field may be reserved. In some embodiments, the indication of the TRP index and whether a new beam is identified can be jointly or separately encoded. For example, with reference to FIG. 3, the field “R” can be used to indicate the TRP index for a cell configured with multiple TRPs and configured to support multi-TRP beam failure recovery and can be used as a reserved field for a cell configured with only one TRP.

In some embodiments, in response to a beam failure being detected on a cell in the group of cells, the terminal device 120 may transmit a BFRQ via a PUSCH MAC CE to the network device 110. In some embodiments, for a cell configured with multiple TRPs and configured to support multi-TRP beam failure recovery, the PUSCH MAC CE may comprise a first field indicating one or two TRPs fails for the cell, a second field indicating a TRP index, and one or more fields indicating if a new beam is identified for the cell and an index of the new beam if it is identified. In some embodiments, the indication by the second field may be different in different cases. For example, if the cell is configured with multiple TRPs and configured to support multi-TRP beam failure recovery and if one TRP fails, the second field may indicate an index of the TRP that fails. If a new beam is identified for the cell, the new beam may be associated with the TRP. For another example, if the cell is configured with multiple TRPs and configured to support multi-TRP beam failure recovery and if two TRP fails, the second field may indicate which one of the TRPs is associated with a new beam if it is identified. If a new beam is identified for the cell, the new beam may be associated with the TRP. In some embodiments, for a cell configured with only one TRP, the first field and/or the second field may be reserved.

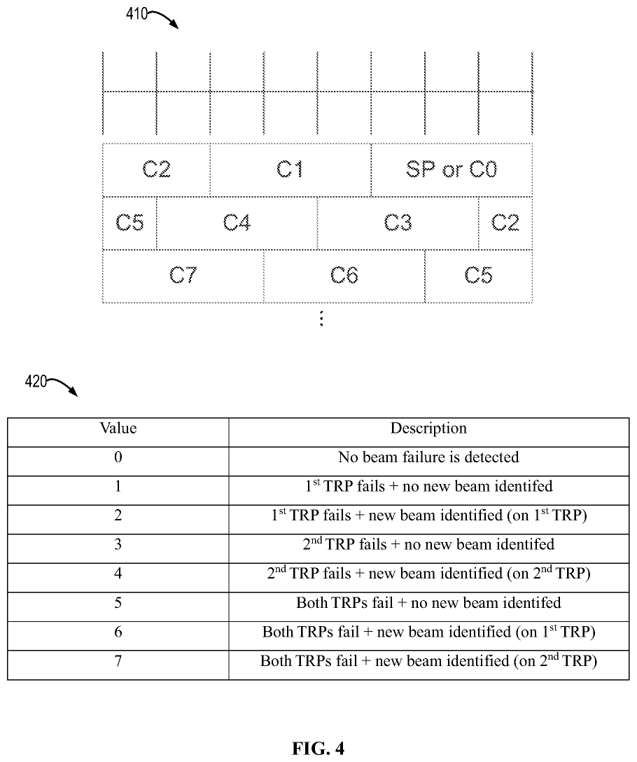

In some embodiments, in response to a beam failure being detected on a cell in the group of cells, the terminal device 120 may transmit a BFRQ via a PUSCH MAC CE to the network device 110. In some embodiments, for each cell reported in the PUSCH MAC CE, the PUSCH MAC CE may indicate at least one of following items: whether a beam failure is detected on the cell, a TRP index, whether one or two TRP fails and whether a new beam is identified for the cell. In some embodiments, at least two of whether a beam failure is detected on the cell, a TRP index, whether one or two TRP fails and whether a new beam is identified for the cell can be jointly encoded. FIG. 4 illustrates an example of such embodiments. FIG. 4 shows an example BFRQ 410, in which each cell (for example, C0, C1 . . . or C7) has a 3 bits field for indicating information about beam failure detection. Table 420 shows possible values of the 3 bits field and corresponding descriptions.

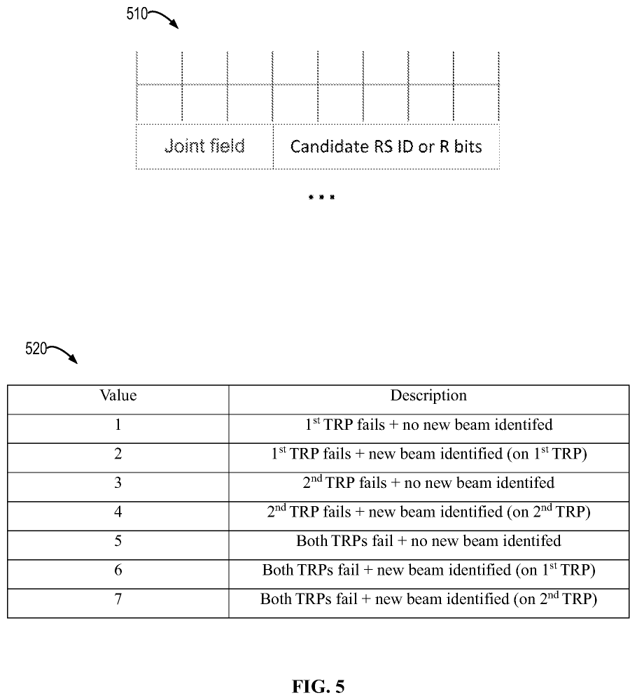

In some embodiments, in response to a beam failure being detected on a cell in the group of cells, the terminal device 120 may transmit a BFRQ via a PUSCH MAC CE to the network device 110. In some embodiments, for each cell reported in the PUSCH MAC CE, the PUSCH MAC CE may indicate at least one of following items: whether a beam failure is detected on the cell, a TRP index, whether one or two TRP fails and whether a new beam is identified for the cell. In some embodiments, whether a beam failure is detected on a cell can be indicated in the PUSCH MAC CE as legacy solutions. Additionally, a TRP index, whether one or two TRP fails and whether a new beam is identified for the cell can be encoded in a joint field. FIG. 5 illustrates an example of such embodiments. FIG. 5 shows an example BFRQ 510, in which each cell has a 3 bits joint field for indicating information about beam failure detection. Table 520 shows possible values of the 3 bits field and corresponding descriptions. In some embodiments, if a cell is configured with two TRPs and multi-TRP beam failure recovery, the maximum number of new beam identification RSs for one TRP of the cell may be up to 32. That is, the field “Candidate RS ID” may occupy 5 bits.

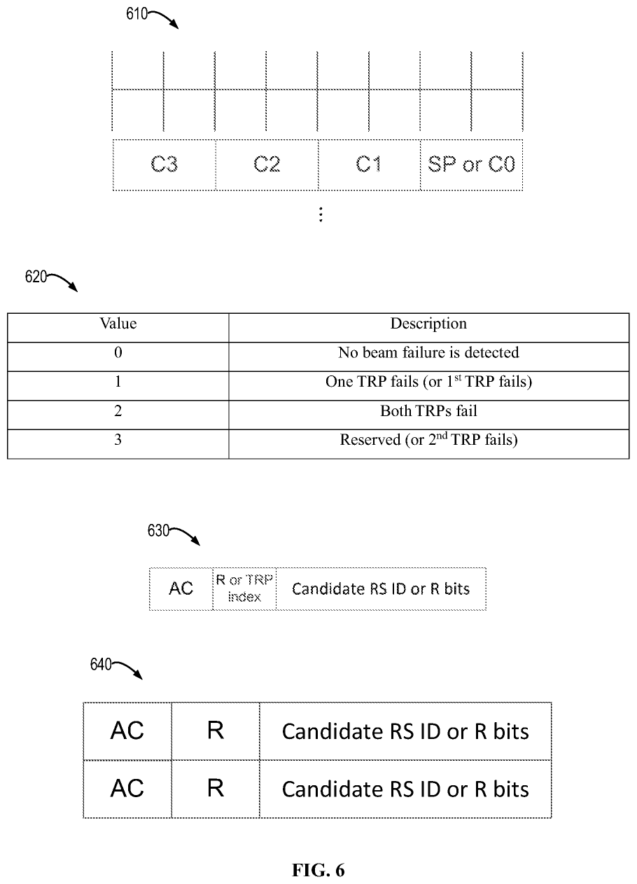

In some embodiments, in response to a beam failure being detected on a cell in the group of cells, the terminal device 120 may transmit a BFRQ via a PUSCH MAC CE to the network device 110. In some embodiments, for each cell reported in the PUSCH MAC CE, the PUSCH MAC CE may indicate at least one of following items: whether a beam failure is detected on the cell, a TRP index, whether one or two TRP fails and whether a new beam is identified for the cell. In some embodiments, whether a beam failure is detected on a cell and whether one or two TRPs fails can be jointly encoded. FIG. 6 illustrates an example of such embodiments. FIG. 6 shows an example BFRQ 610, in which each cell (for example, C0, C1 . . . or C3) has a 2 bits field for indicating information about beam failure detection. Table 620 shows possible values of the 2 bits field and corresponding descriptions. In some embodiments, if the 2 bits field for a cell has a value of 1, there may be one row shown by 630 for the cell in the BFRQ 610. If the 2 bits field for a cell has a value of 2, there may be two rows as shown by 640 for the cell in the BFRQ 610.

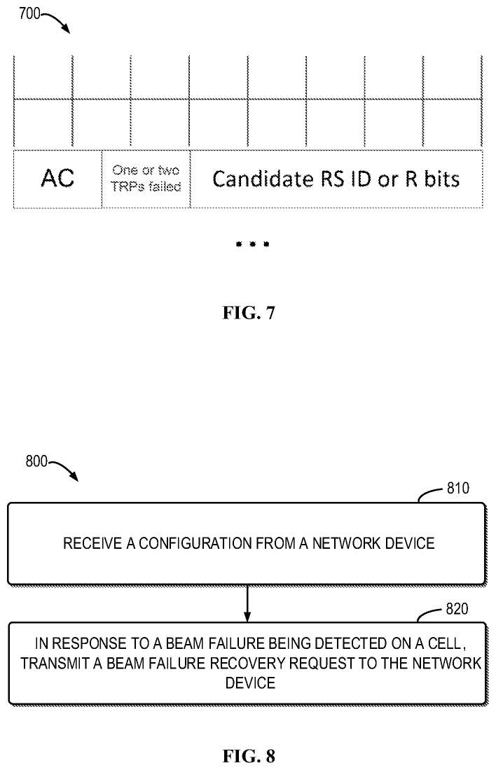

In some embodiments, in response to a beam failure being detected on a cell in the group of cells, the terminal device 120 may transmit a BFRQ via a PUSCH MAC CE to the network device 110. In some embodiments, if a new beam is identified for the cell, the PUSCH MAC CE may indicate a RS index for the new beam, where the RS index may implicitly indicate a TRP index related to the beam failure. In some embodiments, the terminal device 120 may be configured with two candidate RS lists, for example, List_1 and List_2. The number of RSs in List_1 may be N1, where N1 is a positive integer and 1≤N1≤64. The number of RSs in List_2 may be N2, where N2 is a positive integer and 1≤N2≤64. The total number of RSs in List_1 and List_2 may be up to M, for example, M=64. In some embodiments, in the PUSCH MAC CE for BFRQ, the candidate RS ID may be set to the index of entry in the combined list of List_1 and List_2. FIG. 7 illustrates an example of such embodiments. FIG. 7 shows an example BFRQ 700, in which there is one field to indicate whether one or two TRPs fail for a cell. In some embodiments, if the value of this field is 0, it means only one TRP fails and there may be one row for reporting the candidate RS ID. In this event, the TRP index may be implicitly indicated by the candidate RS ID. For example, if the value of the candidate RS ID is between 0 and N1−1, it indicates that the first TRP fails; while if the value of the candidate RS ID is between N1 and N1+N2−1, it indicates that the second TRP fails. In some embodiments, if the value of this field is 1, it means two TRPs fail and there may be two rows for reporting the candidate RS IDs for the two TRPs.

In some embodiments, for the group of cells provided by the network device 110 for serving the terminal device 120, if Cell-1 is configured with multiple TRPs (for example, 2 TRPs), up to 2 PUCCH-scheduling request (PUCCH-SR) resources can be configured. For example, if 2 PUCCH-SR resources (for example, SR1 and SR2) are configured, SR1 may be associated with the first TRP and SR2 may be associated with the second TRP.

In some embodiments, for the group of cells provided by the network device 110 for serving the terminal device 120, if Cell-1 is configured with a single TRP, up to 1 PUCCH-SR resource can be configured.

In some embodiments, for the group of cells provided by the network device 110 for serving the terminal device 120, if Cell-1 is configured with a single TRP, and at least one of Cell-X is configured with multiple TRPs (for example, 2 TRPs), up to 2 PUCCH-SR resources can be configured. For example, if 2 PUCCH-SR resources (for example, SR1 and SR2) are configured, SR1 may be associated with the first TRP for the Cell-X and SR2 may be associated with the second TRP for the Cell-X.

FIG. 8 illustrates a flowchart of an example method 800 in accordance with some embodiments of the present disclosure. For example, the method 800 can be implemented at the terminal device 120 as shown in FIG. 1.

At block 810, the terminal device 120 receives a configuration from a network device (for example, the network device 110 as shown in FIG. 1), where the configuration indicates that each of a group of cells serving the terminal device is associated with at least one of a plurality of TRPs (for example, the TRPs 130-1 and 130-2 as shown in FIG. 1) coupled with the network device.

At block 820, in response to a beam failure being detected on a cell in the group of cells, the terminal device 120 transmits a beam failure recovery request to the network device, where the beam failure recovery request comprises TRP information related to the beam failure detected on the cell.

In some embodiments, each of the plurality of TRPs may be represented by at least one of the following: a CORESET pool index; a CORESET group identifier; an identifier of a set of RSs for beam failure detection; an identifier of a set of RSs for new beam identification; spatial relation information; a SRS resource set; a TCI state; and a set of QCL parameters.

In some embodiments, the plurality of TRPs may comprise a first TRP and a second TRP, the group of cells may comprise a first subset of cells associated with the first TRP and a second subset of cells associated with the second TRP, the first subset of cells may be configured with a first set of RSs for beam failure detection and a second set of RSs for new beam identification, and the second subset of cells may be configured with a third set of RSs for beam failure detection and a fourth set of RSs for new beam identification.

In some embodiments, in response to a beam failure being detected based on the first set of RSs, the terminal device 120 may transmit a first beam failure recovery request to the network device, where the first beam failure recovery request at least comprises an indication of the first TRP or the first subset of cells. In response to a beam failure being detected based on the third set of RSs, the terminal device 120 may transmit a second beam failure recovery request to the network device, where the second beam failure recovery request at least comprises an indication of the second TRP or the second subset of cells.

In some embodiments, the cell may be associated with the plurality of TRPs and the TRP information may indicate one of the plurality of TRPs related to the beam failure detected on the cell.

In some embodiments, the TRP information may comprise an indication of a TRP index common to all cells indicated in the beam failure recovery request.

In some embodiments, the TRP information may comprise an indication of a respective TRP index for each of cells indicated in the beam failure recovery request.

In some embodiments, the cell may be associated with the plurality of TRPs and the TRP information may comprise at least one of the following: first information indicating the number of TRPs related to the beam failure detected on the cell; second information indicating an index of one of the plurality of TRPs related to the beam failure detected on the cell; and third information indicating on which one of the plurality of TRPs a new beam is identified.

In some embodiments, the cell may be associated with the plurality of TRPs and the TRP information may comprise: first information indicating the number of TRPs related to the beam failure detected on the cell; and second information indicating a RS index for a new beam identified on one TRP of the plurality of TRPs, where the RS index indicates an index of the one TRP.

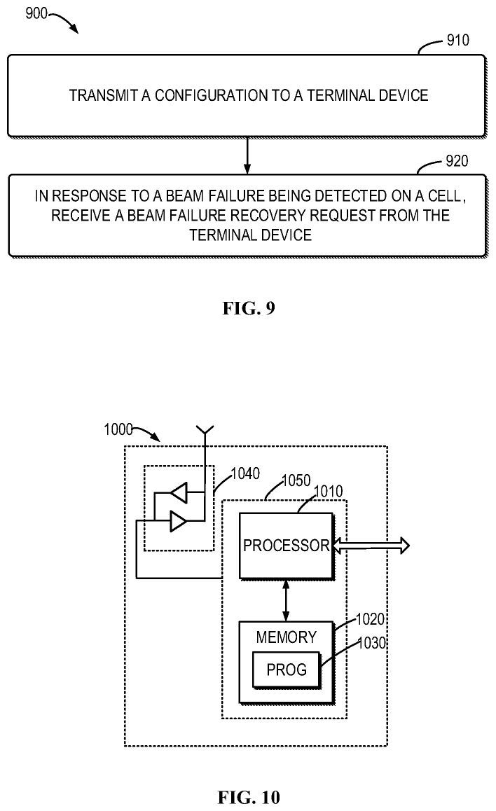

FIG. 9 illustrates a flowchart of an example method 900 in accordance with some embodiments of the present disclosure. For example, the method 900 can be implemented at the network device 110 as shown in FIG. 1.

At block 910, the network device 110 transmits a configuration to a terminal device (for example, the terminal device 120 as shown in FIG. 1), where the configuration indicates that each of a group of cells serving the terminal device is associated with at least one of a plurality of TRPs (for example, the TRPs 130-1 and 130-2 as shown in FIG. 1) coupled with the network device 110.

At block 920, in response to a beam failure being detected on a cell in the group of cells, the network device 110 receives a beam failure recovery request from the terminal device, where the beam failure recovery request comprises TRP information related to the beam failure detected on the cell.

In some embodiments, each of the plurality of TRPs may be represented by at least one of the following: a CORESET pool index; a CORESET group identifier; an identifier of a set of RSs for beam failure detection; an identifier of a set of RSs for new beam identification; spatial relation information; a SRS resource set; a TCI state; and a set of QCL parameters.

In some embodiments, the plurality of TRPs may comprise a first TRP and a second TRP, the group of cells may comprise a first subset of cells associated with the first TRP and a second subset of cells associated with the second TRP, the first subset of cells may be configured with a first set of RSs for beam failure detection and a second set of RSs for new beam identification, and the second subset of cells may be configured with a third set of RSs for beam failure detection and a fourth set of RSs for new beam identification.

In some embodiments, in response to a beam failure being detected based on the first set of RSs, the network device 110 may receive a first beam failure recovery request from the terminal device, where the first beam failure recovery request at least comprises an indication of the first TRP or the first subset of cells. In response to a beam failure being detected based on the third set of RSs, the network device 110 may receive a second beam failure recovery request from the terminal device, where the second beam failure recovery request at least comprises an indication of the second TRP or the second subset of cells.

In some embodiments, the cell may be associated with the plurality of TRPs and the TRP information may indicate one of the plurality of TRPs related to the beam failure detected on the cell.

In some embodiments, the TRP information may comprise an indication of a TRP index common to all cells indicated in the beam failure recovery request.

In some embodiments, the TRP information may comprise an indication of a respective TRP index for each of cells indicated in the beam failure recovery request.

In some embodiments, the cell may be associated with the plurality of TRPs and the TRP information may comprise at least one of the following: first information indicating the number of TRPs related to the beam failure detected on the cell; second information indicating an index of one of the plurality of TRPs related to the beam failure detected on the cell; and third information indicating on which one of the plurality of TRPs a new beam is identified.

In some embodiments, the cell may be associated with the plurality of TRPs and the TRP information may comprise: first information indicating the number of TRPs related to the beam failure detected on the cell; and second information indicating a RS index for a new beam identified on one TRP of the plurality of TRPs, where the RS index indicates an index of the one TRP.

In some embodiments, a terminal device comprises circuitry configured to: receive a configuration from a network device, wherein the configuration indicates that each of a group of cells serving the terminal device is associated with at least one of a plurality of transmission and reception points (TRPs) coupled with the network device; and in response to a beam failure being detected on a cell in the group of cells, transmit a beam failure recovery request to the network device, wherein the beam failure recovery request comprises TRP information related to the beam failure detected on the cell.

In some embodiments, each of the plurality of TRPs is represented by at least one of the following: a control resource set (CORESET) pool index; a CORESET group identifier; an identifier of a set of reference signals (RSs) for beam failure detection; an identifier of a set of RSs for new beam identification; spatial relation information; a sounding reference signal (SRS) resource set; a transmission configuration indicator (TCI) state; and a set of quasi co-location parameters.

In some embodiments, the plurality of TRPs comprise a first TRP and a second TRP, the group of cells comprise a first subset of cells associated with the first TRP and a second subset of cells associated with the second TRP, the first subset of cells are configured with a first set of RSs for beam failure detection and a second set of RSs for new beam identification, and the second subset of cells are configured with a third set of RSs for beam failure detection and a fourth set of RSs for new beam identification.

In some embodiments, the terminal device comprises circuitry configured to: in response to a beam failure being detected based on the first set of RSs, transmit a first beam failure recovery request to the network device, wherein the first beam failure recovery request at least comprises an indication of the first TRP or the first subset of cells; and in response to a beam failure being detected based on the third set of RSs, transmit a second beam failure recovery request to the network device, wherein the second beam failure recovery request at least comprises an indication of the second TRP or the second subset of cells.

In some embodiments, the cell is associated with the plurality of TRPs and the TRP information indicates one of the plurality of TRPs related to the beam failure detected on the cell.

In some embodiments, the TRP information comprises an indication of a TRP index common to all cells indicated in the beam failure recovery request.

In some embodiments, the TRP information comprises an indication of a respective TRP index for each of cells indicated in the beam failure recovery request.

In some embodiments, the cell is associated with the plurality of TRPs and the TRP information comprises at least one of the following: first information indicating the number of TRPs related to the beam failure detected on the cell; second information indicating an index of one of the plurality of TRPs related to the beam failure detected on the cell; and third information indicating on which one of the plurality of TRPs a new beam is identified.

In some embodiments, the cell is associated with the plurality of TRPs and the TRP information comprises: first information indicating the number of TRPs related to the beam failure detected on the cell; and second information indicating a RS index for a new beam identified on one TRP of the plurality of TRPs, wherein the RS index indicates an index of the one TRP.

In some embodiments, a network device comprises circuitry configured to: transmit a configuration from to a terminal device, wherein the configuration indicates that each of a group of cells serving the terminal device is associated with at least one of a plurality of transmission and reception points (TRPs) coupled with the network device; and in response to a beam failure being detected on a cell in the group of cells, receive a beam failure recovery request from the terminal device, wherein the beam failure recovery request comprises TRP information related to the beam failure detected on the cell.

In some embodiments, each of the plurality of TRPs is represented by at least one of the following: a control resource set (CORESET) pool index; a CORESET group identifier; an identifier of a set of reference signals (RSs) for beam failure detection; an identifier of a set of RSs for new beam identification; spatial relation information; a sounding reference signal (SRS) resource set; a transmission configuration indicator (TCI) state; and a set of quasi co-location parameters.

In some embodiments, the plurality of TRPs comprise a first TRP and a second TRP, the group of cells comprise a first subset of cells associated with the first TRP and a second subset of cells associated with the second TRP, the first subset of cells are configured with a first set of RSs for beam failure detection and a second set of RSs for new beam identification, and the second subset of cells are configured with a third set of RSs for beam failure detection and a fourth set of RSs for new beam identification.

In some embodiments, the network device comprises circuitry configured to: in response to a beam failure being detected based on the first set of RSs, receive a first beam failure recovery request from the terminal device, wherein the first beam failure recovery request at least comprises an indication of the first TRP or the first subset of cells; and in response to a beam failure being detected based on the third set of RSs, receive a second beam failure recovery request from the terminal device, wherein the second beam failure recovery request at least comprises an indication of the second TRP or the second subset of cells.

In some embodiments, the cell is associated with the plurality of TRPs and the TRP information indicates one of the plurality of TRPs related to the beam failure detected on the cell.

In some embodiments, the TRP information comprises an indication of a TRP index common to all cells indicated in the beam failure recovery request.

In some embodiments, the TRP information comprises an indication of a respective TRP index for each of cells indicated in the beam failure recovery request.

In some embodiments, the cell is associated with the plurality of TRPs and the TRP information comprises at least one of the following: first information indicating the number of TRPs related to the beam failure detected on the cell; second information indicating an index of one of the plurality of TRPs related to the beam failure detected on the cell; and third information indicating on which one of the plurality of TRPs a new beam is identified.

In some embodiments, the cell is associated with the plurality of TRPs and the TRP information comprises: first information indicating the number of TRPs related to the beam failure detected on the cell; and second information indicating a RS index for a new beam identified on one TRP of the plurality of TRPs, wherein the RS index indicates an index of the one TRP.

FIG. 10 is a simplified block diagram of a device 1000 that is suitable for implementing embodiments of the present disclosure. The device 1000 can be considered as a further example implementation of the network device 110, the TRP 130 and/or the terminal device 120 as shown in FIG. 1. Accordingly, the device 1000 can be implemented at or as at least a part of the network device 110, the TRP 130 and/or the terminal device 120 as shown in FIG. 1.

As shown, the device 1000 includes a processor 1010, a memory 1020 coupled to the processor 1010, a suitable transmitter (TX) and receiver (RX) 1040 coupled to the processor 1010, and a communication interface coupled to the TX/RX 1040. The memory 1010 stores at least a part of a program 1030. The TX/RX 1040 is for bidirectional communications. The TX/RX 1040 has at least one antenna to facilitate communication, though in practice an Access Node mentioned in this application may have several ones. The communication interface may represent any interface that is necessary for communication with other network elements, such as X2 interface for bidirectional communications between eNBs, SI interface for communication between a Mobility Management Entity (MME)/Serving Gateway (S-GW) and the eNB, Un interface for communication between the eNB and a relay node (RN), or Uu interface for communication between the eNB and a terminal device.

The program 1030 is assumed to include program instructions that, when executed by the associated processor 1010, enable the device 1000 to operate in accordance with the embodiments of the present disclosure, as discussed herein with reference to FIG. 1 to FIG. 9. The embodiments herein may be implemented by computer software executable by the processor 1010 of the device 1000, or by hardware, or by a combination of software and hardware. The processor 1010 may be configured to implement various embodiments of the present disclosure. Furthermore, a combination of the processor 1010 and memory 1020 may form processing means 1050 adapted to implement various embodiments of the present disclosure.

The memory 1020 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 1020 is shown in the device 1000, there may be several physically distinct memory modules in the device 1000. The processor 1010 may be of any type suitable to the local technical network, and may include one or more of general purpose computers, special purpose computers, microprocessors, digital signal processors (DSPs) and processors based on multicore processor architecture, as non-limiting examples. The device 1000 may have multiple processors, such as an application specific integrated circuit chip that is slaved in time to a clock which synchronizes the main processor.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 10 and 11. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1-22. (canceled)

23. A method, performed by a terminal device, comprising:
performing, beam failure detection for a cell based on two reference signal (RS) sets; and
transmitting, to a network device, a medium access control (MAC) control element (CE) for beam failure recovery, the MAC CE comprising
a first field indicating whether beam failure is detected for the cell,
a second field indicating whether beam failure is detected for one or both of the RS sets, of the cell, and
a third field indicating presence of a candidate RS identifier (ID) field,
wherein:
the second field being 1 indicates that beam failure is detected for both the RS sets, and two octets containing the third field are present for both the RS sets, and
the second field being 0 indicates that beam failure is detected for one of the RS sets, and one octet containing the third field is present for only one RS set of the cell.

24. The method of claim 23, wherein
the MAC CE further comprises a fourth field indicating a RS set ID.

25. The method of claim 23, wherein
the MAC CE further comprises a fifth field indicating a candidate RS ID.

26. The method of claim 25, wherein
the fifth field is also contained in the one octet.

27. The method of claim 25, wherein
the fifth field is also contained in the two octets.

28. The method of claim 23, wherein
up to two PUCCH resources for scheduling request (SR) are configured, the two PUCCH resources are associated with at least one of the RS sets.

29. A method, performed by a network device, comprising:
receiving, from a terminal device, a medium access control (MAC) control element (CE) for beam failure recovery, the MAC CE comprising
a first field indicating whether beam failure is detected for a cell, wherein the cell is configured with two reference signal (RS) sets for beam failure detection,
a second field indicating whether beam failure is detected for one or both of the RS sets, of the cell, and
a third field indicating presence of a candidate RS identifier (ID) field,
wherein:
the second field being 1 indicates that beam failure is detected for both the RS sets, and two octets containing the third field are present for both the RS sets, and
the second field being 0 indicates that beam failure is detected for one of the RS sets, and one octet containing the third field is present for only one RS set of the cell.

30. The method of claim 29, wherein
the MAC CE further comprises a fourth field indicating a RS set ID.

31. The method of claim 29, wherein
the MAC CE further comprises a fifth field indicating a candidate RS ID.

32. The method of claim 31, wherein
the fifth field is also contained in the one octet.

33. The method of claim 31, wherein
the fifth field is also contained in the two octets.

34. The method of claim 29, wherein
up to two PUCCH resources for scheduling request (SR) are configured, the two PUCCH resources are associated with at least one of the RS sets.

35. A terminal device, comprising a processor configured to cause the terminal device to:
perform, beam failure detection for a cell based on two reference signal (RS) sets; and
transmit, to a network device, a medium access control (MAC) control element (CE) for beam failure recovery, the MAC CE comprising
a first field indicating whether beam failure is detected for the cell,
a second field indicating whether beam failure is detected for one or both of the RS sets, of the cell, and
a third field indicating presence of a candidate RS identifier (ID) field,
wherein:
the second field being 1 indicates that beam failure is detected for both the RS sets, and two octets containing the third field are present for both the RS sets, and
the second field being 0 indicates that beam failure is detected for one of the RS sets, and one octet containing the third field is present for only one RS set of the cell.

36. The terminal device of claim 35, wherein
the MAC CE further comprises a fourth field indicating a RS set ID.

37. The terminal device of claim 35, wherein
the MAC CE further comprises a fifth field indicating a candidate RS ID.

38. The terminal device of claim 37, wherein
the fifth field is also contained in the one octet.

39. The terminal device of claim 37, wherein
the fifth field is also contained in the two octets.

40. The terminal device of claim 35, wherein
up to two PUCCH resources for scheduling request (SR) are configured, the two PUCCH resources are associated with at least one of the RS sets.

41. A network device, comprising a processor configured to cause the network device to:
receiving, from a terminal device, a medium access control (MAC) control element (CE) for beam failure recovery, the MAC CE comprising
a first field indicating whether beam failure is detected for a cell, wherein the cell is configured with two reference signal (RS) sets for beam failure detection,
a second field indicating whether beam failure is detected for one or both of the RS sets, of the cell, and
a third field indicating presence of a candidate RS identifier (ID) field,
wherein:
the second field being 1 indicates that beam failure is detected for both the RS sets, and two octets containing the third field are present for both the RS sets, and
the second field being 0 indicates that beam failure is detected for one of the RS sets, and one octet containing the third field is present for only one RS set of the cell.

42. The network device of claim 41, wherein
the MAC CE further comprises a fourth field indicating a RS set ID.
